(19) United States
(12) Patent Application Publication
(10) Pub. No.: US 2025/0244520 A1
(43) Pub. Date: Jul. 31, 2025

(54) LIGHTING SYSTEM INCLUDING DIFFUSION CONTROL

(71) Applicant: JoysonQuin Automotive Systems North America, LLC, Troy, MI (US)

(72) Inventors: Kirk Anderson, Hattersheim am Main (DE); Mario J. Enriquez Ortiz, Troy, MI (US)

(21) Appl. No.: 19/040,581

(22) Filed: Jan. 29, 2025

Related U.S. Application Data
(60) Provisional application No. 63/627,371, filed on Jan. 31, 2024.

(51) Int. Cl. F21V 8/00

(52) U.S. Cl. CPC G02B 6/0051; G02B 6/006; G02B 6/0061; G02B 6/0068; G02B 6/0073; G02B 6/0088

(57) ABSTRACT

A lighting assembly includes a light guide; and a plurality of light sources configured to emit light into an edge of the light guide, wherein the light guide includes a plurality of air gaps arranged such that each air gap of the plurality of air gaps (i) is parallel with another air gap, (ii) is between adjacent light sources of the plurality of light sources, and (iii) extends in a direction in which light from the plurality of light sources is propagating in the light guide.

### CROSS-REFERENCE TO RELATED APPLICATIONS

This application claims the benefit of U.S. Provisional Patent Application No. 63/627,371, filed Jan. 31, 2024, which is hereby incorporated by reference for all purposes as if fully set forth herein.

### BACKGROUND

The present disclosure relates to lighting systems including light guides. More specifically, the present disclosure relates to lighting systems including a light guide with light diffusion control features.

Lighting modules or lighting units are used to add light in situations to produce a visible image. A backlight module or backlight unit can be used to illuminate a liquid crystal display (LCD) as LCDs do not produce light. A backlight unit illuminates a LCD from the back of the display panel. For reflective LCDs, a front light unit can illuminate a LCD from the front of the display panel so that the LCD can be readable in low ambient lighting conditions. Lighting units can also be used in decorative applications, appliques, or signage.

A conventional lighting unit can include a light source, a light guide, and light control structures. A light source can be any of different types, i.e., a fluorescent lamp, an incandescent lamp, a light-emitting diode (LED), etc. A light guide can be a substantially planar optical structure or film used to direct or channel the light captured from the light source to a location where the light is desired. In direct lighting, the light source illuminates a light guide on one major surface. In edge lighting, the light source illuminates the light guide along an edge. Light control features can be provided by optical structures to manipulate the light emitted from the light source. For example, light control structures can include a diffuser to spread out light and increase lighting uniformity, a color filter to change the color of the light, a reflector to conserve light, a polarizer to change light properties, and the like.

When edge lighting a light guide film with a plurality of LEDs, the light from every single LED diffuses throughout the light guide film as it travels through the film. It is usually desirable to have uniform lighting from a number of light emitters. However, when creating motion light effects such as can be created when individually controlling the color/brightness of every LED used, excessive diffusion results in a blurry pattern. In such cases, it is desirable to control the amount of light diffusion that occurs in the light guide film, particularly diffusion that happens in the non-visible areas of the lighting unit (as the LEDs are usually outside the visible area of the part).

To maximize lighting efficiency, minimize power, dissipate heat, and achieve desired lighting results in a lighting unit, it is necessary to manage and control the light in a lighting unit for the specific application.

### SUMMARY

Disclosed embodiments provide features and methods to minimize light diffusion in lighting units using point light sources, such as LEDs. Such result can be desirable in dynamic lighting applications. Some materials are not easily lit from behind, the disclosed features allow the creation of complex iconography and graphics directly on the surface of such materials like wood, carbon fiber, stone, aluminum, etc.

Light guides including light diffusion control provide images with higher resolution, brightness, contrast, and quality. In some embodiments, a light guide can include air gaps to create lighting channels in non-visible areas. In some embodiments, a light guide can include absorptive lines to create lighting channels in visible areas. In some embodiments, a light guide can include both air gaps and absorptive lines.

It some applications it is desirable to control the amount of diffusion that occurs, particularly diffusion that happens in the non-visible areas of the structure. Films with light dispersion control allow for minimal dispersion of light, resulting in images with better resolution and quality, with more brightness and high contrast. Some materials are not easily lit from behind, this technology allows the creation of complex iconography and graphics directly on the surface of the materials.

In an embodiment, a lighting assembly includes a light guide; and a plurality of light sources configured to emit light into an edge of the light guide, wherein the light guide includes a plurality of air gaps arranged such that each air gap of the plurality of air gaps (i) is parallel with another air gap, (ii) is between adjacent light sources of the plurality of light sources, and (iii) extends in a direction in which light from the plurality of light sources is propagating in the light guide.

In an aspect, the light guide includes a diffusion zone on a side closest to the plurality of light sources and a homogeneous zone passed the diffusion zone, and the air plurality of air gaps are located and/or disposed in the diffusion zone.

In an aspect, the diffusion zone is hidden from a viewer and light emitted from the plurality of light sources is mixed in the homogeneous zone and viewable by the viewer.

In an aspect, the light guide is flexible such that the diffusion zone is wrapped around and located behind a background.

In an aspect, each air gap of the plurality of air gaps is configured to substantially eliminate light travel across the air gap.

In an aspect, each air gap of the plurality of air gaps is filled with a light absorptive material.

In an aspect, at least some air gaps of the plurality of air gaps are filled with a light absorptive material.

In an aspect, a surface of the light guide located at or adjacent to the plurality of air gaps is covered with a light absorbing material.

In an aspect, a surface of the light guide located at or adjacent to the plurality of air gaps is covered with a light reflecting material.

In an aspect, each light source of the plurality of light sources is a light-emitting diode.

In an aspect, the plurality of light sources includes a plurality of light-emitting diodes.

In an aspect, the light guide includes a protective layer disposed on at least one major surface.

In an aspect, the light guide includes a plurality of parallel light absorptive lines that are respectively aligned with at least one air gap of the plurality of air gaps.

In an aspect, the plurality of light absorptive lines are located on or in one major surface of the light guide.

In an aspect, the plurality of light absorptive lines are located on or in two major surfaces of the light guide.

In an aspect, a décor that is front lit by the lighting assembly.

In another embodiment, a display system includes a reflective display; a background located behind the reflective display; and a lighting assembly configured to front light the reflective display, wherein the lighting assembly includes a light guide, a plurality of light sources configured to emit light into an edge of the light guide, a plurality of air gaps arranged in the planar light guide such that each air gap of the plurality of air gaps (i) is parallel with another air gap, (ii) is between adjacent light sources of the plurality of light sources, and (iii) extends in a direction in which light from the plurality of light sources is propagating in the light guide. In an aspect, the diffusion zone is located within an enclosure.

The above and other features, elements, characteristics, steps, and advantages of the present invention will become more apparent from the following detailed description of preferred embodiments of the present invention with reference to the attached drawings.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1A and FIG. 1B show an application for a lighting unit.

FIG. 2A and FIG. 2B show a configuration of a front lighting unit.

FIG. 3 shows an edge lighting unit.

FIG. 4 shows a configuration of a light guide according to an exemplary embodiment.

FIG. 5 is a representation of a side view of a light guide.

FIG. 6 to FIG. 9 are representative side views of light guides that illuminate decors.

FIG. 10 shows a configuration of a lighting unit according to an exemplary embodiment.

FIG. 11 to FIG. 16 are results from a ray tracing simulation in a light guide with no air gaps.

FIG. 17 to FIG. 24 are results from a ray tracing simulation in a light guide with air gaps.

FIG. 25 is a front planar view of a portion of a lighting unit according to an exemplary embodiment.

### DETAILED DESCRIPTION

Reference will now be made in detail to embodiments of the present disclosure, examples of which are illustrated in the accompanying drawings. Whenever possible, the same reference numerals will be used throughout the drawings to refer to the same or like parts. However, this disclosure may be embodied in many different forms and should not be construed as limited to the embodiments set forth herein.

Ranges can be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

Directional terms as used herein—for example up, down, right, left, front, back, top, bottom, vertical, horizontal—are made only with reference to the figures as drawn and are not intended to imply absolute orientation.

Unless otherwise expressly stated, it is in no way intended that any method set forth herein be construed as requiring that its steps be performed in a specific order, nor that with any apparatus, specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including matters of logic with respect to arrangement of steps, operational flow, order of components, or orientation of components; plain meaning derived from grammatical organization or punctuation, and; the number or type of embodiments described in the specification.

As used herein, the singular forms “a,” “an,” and “the” include plural references unless the context clearly dictates otherwise. Thus, for example, reference to “a” component includes aspects having two or more such components, unless the context clearly indicates otherwise.

In the following description, reference is made to the accompanying drawings that form a part thereof, and in which is shown by way of illustrating specific exemplary embodiments in which the disclosure may be practiced. These embodiments are described in sufficient detail to enable those skilled in the art to practice the concepts disclosed herein, and it is to be understood that modifications to the various disclosed embodiments may be made, and other embodiments may be utilized, without departing from the scope of the present disclosure. The following detailed description is, therefore, not to be taken in a limiting sense.

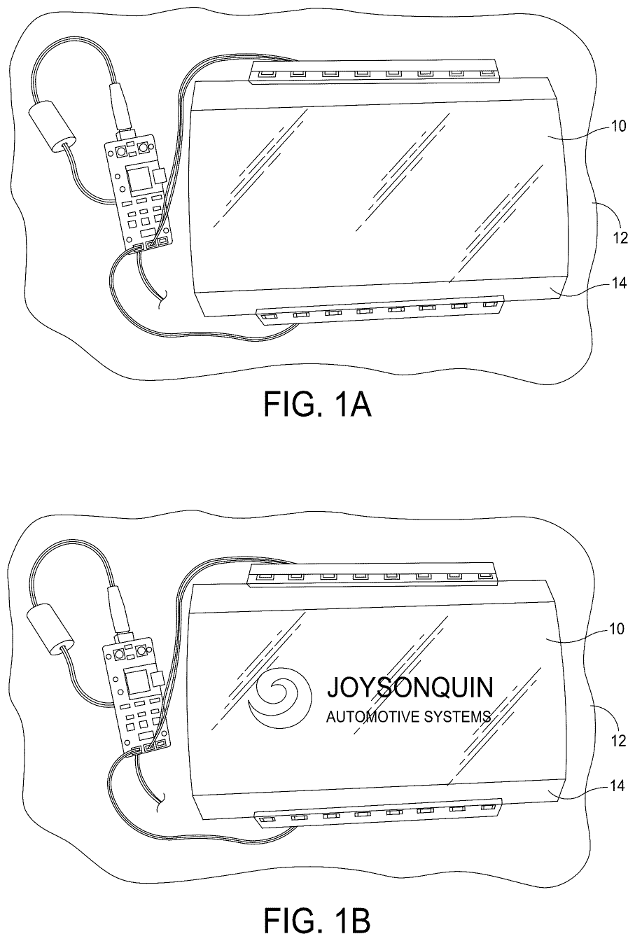

FIGS. 1A and 1B show one example of an application for a lighting unit. For example, the lighting unit can be used to present electronically generated information and/or decorative graphics in a front lighting application for a reflective display. As shown, the application can be used to display icons, graphics, and logos on a reflective display in front of difficult to light materials like wood, leather, carbon fiber, stone, metals, textiles, and more. The application shown in FIG. 1 can include a reflective display or decor 10, a background 12, and electronics 14 for an enclosure (not shown). The electronics 14 can include a power supply, a light source, control electronics to drive the display and the light source, and a housing.

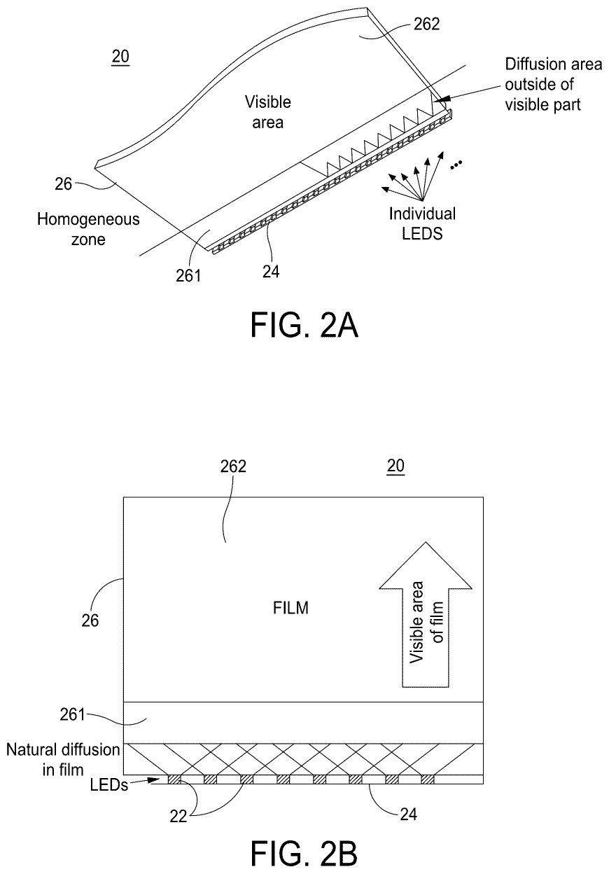

The lighting unit permits viewing of complex iconography and graphics of a reflective display directly in front of a surface of the background. FIGS. 2A and 2B show one example of a configuration of a lighting unit such as can be used to front light the reflective display shown in FIG. 1. FIG. 2A is a perspective view of a portion of a lighting unit 20. FIG. 2B is a front planar view of a portion of the lighting unit 20. The lighting unit 20 can have an edge-lighting configuration in that a plurality of LEDs 22 mounted to a circuit board 24 are used to emit light into an edge of a light guide 26. The LEDs 22 can be white, one color, multi-color, or include several LEDs emitting different colors.

The straight lines across the light guide 26 in FIGS. 2A and 2B represent a virtual delineation of two lighting zones in the light guide 26. The area on a side of the lines closest to the LEDs 22 can be a diffusion zone 261 where light emitted from the different LEDs 22 diffuse and mix together to define a uniform or homogeneous zone 262 that can be an area on the other side of the lines.

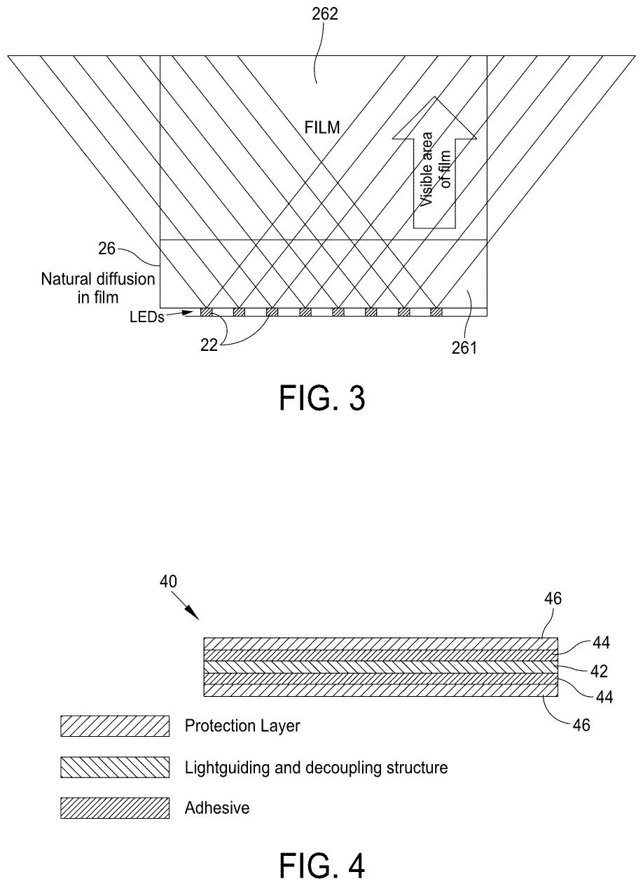

LEDs are effectively point light sources that require space to diffuse to define a uniform pattern, especially when light from multiple LEDs are used. This property is shown with respect to FIG. 3 that depicts light being emitted from individual LEDs 22 in a conical pattern. Emitted light closer to the LEDs 22 may not be as uniform as light that has been mixed from multiple LEDs 22 farther away from the LEDs 22. Lighting in the diffusion zone 261 can be non-uniform or not pleasing enough to be used in a visual or display application. Consequently, the diffusion zone 261 of the light guide 26 can be hidden or out of sight of a viewer. For example, in the application shown in FIG. 1, the diffusion zone can be located within the enclosure so that the non-uniform light emitted from the LEDs is not visible. In other applications, the light guide can be flexible such that the diffusion zone can be wrapped around and located behind the background.

FIG. 4 shows one example of a geometric configuration of a light guide 40 according to an embodiment. As shown, the light guide 40 can include a centrally located substantially planar light-guiding and decoupling structure 42 that can be bonded on top and bottom with protection layers 46 using an optical adhesive 44. The light-guiding and decoupling structure 42 can be a sheet or film of optical material such as polycarbonate, acrylic, glass, or any other suitable material. The protection layers 46 can also be a sheet or film of optical material such as polycarbonate, acrylic, glass, or any other suitable material. The adhesive 44 can be any suitable optical grade adhesive including silicone, epoxy, and the like. In some embodiments, the adhesive 44 can be a liquid, gel, or sheet and can be UV, humidity, temperature, or self-curable. In some embodiments, the adhesive 44 can be a pressure sensitive adhesive (PSA). The adhesive 44 must have an index of refraction lower than the light-guiding and decoupling structure 42 so that total internal reflection occurs within the light guide 40.

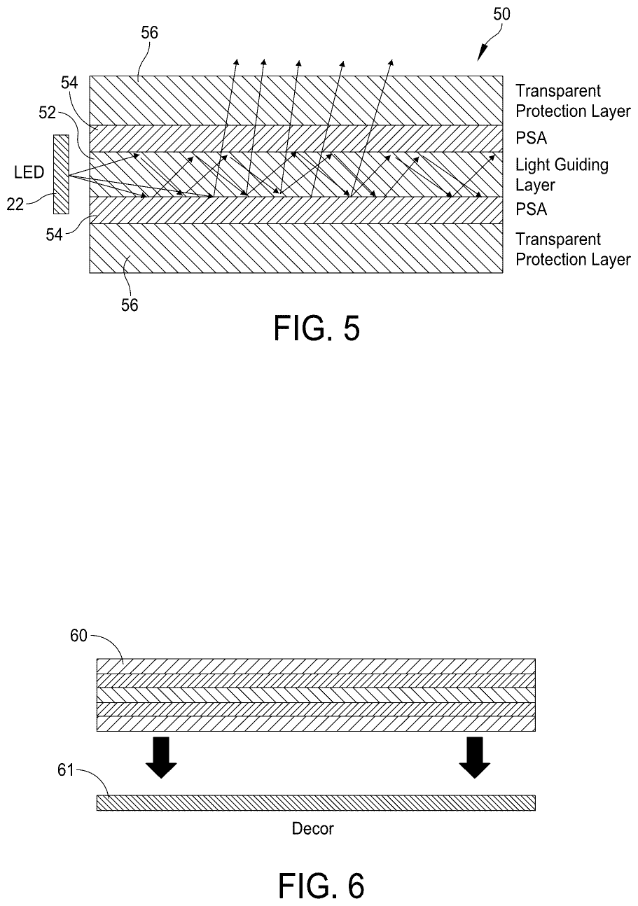

FIG. 5 is one example of a representation of a side view of a light guide 50 showing light rays emitted by an LED 22 traveling in the light guide 50. The light guide 50 can include a light guiding layer 52 that is protected on the top and bottom surfaces by transparent protection layers 56 that are bonded to the light guiding layer 52 using a PSA 54. As shown, light rays can be emitted by the LED 22 into the light guiding layer 52. The light rays can generally travel through the light guiding layer 52 in three dimensions via total internal reflection until the angle of incidence of a light ray increases to the critical angle and the light ray exits the light guiding layer 52. Reflectors (not shown), management of the index of refraction of the various layers, and other means can be used to control the direction of light output from the light guide 50.

In an example embodiment, the light guiding layer 52 can be 50 μm thick, the PSA 54 layers can each be a 40 μm thick, and the protection layers 56 can be 100 μm thick. The PSA 54 layers can be a silicone-based adhesive and the protection layers 56 can be polycarbonate. In another example embodiment, the light guiding layer 52 can be 50 μm thick, the PSA 54 layers can each be 40 μm thick, and the protection layers 56 can be 50 μm thick. In another example embodiment, the light guiding layer 52 can be 50 μm thick, the PSA 54 layers can each be 40 μm thick, one protection layer 56 can be 100 μm thick and the other protection layer 56 can be 50 μm thick. However, one of ordinary skill in the art will understand that these thicknesses are merely illustrative and the layers may have other suitable thicknesses.

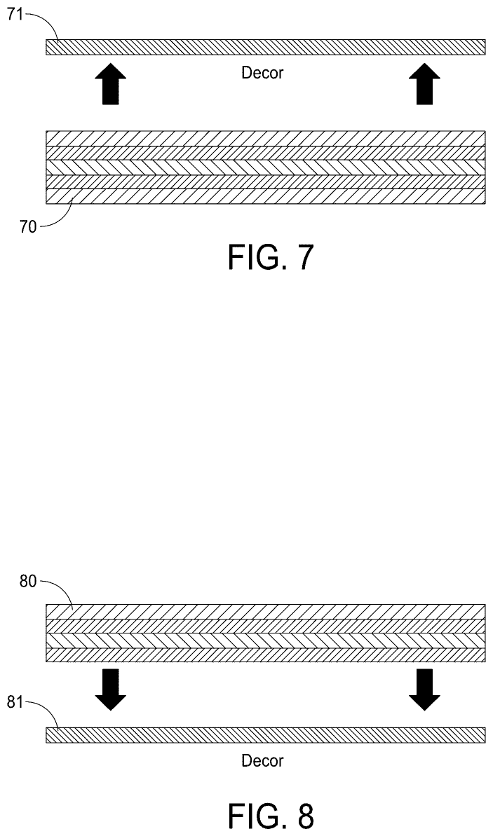

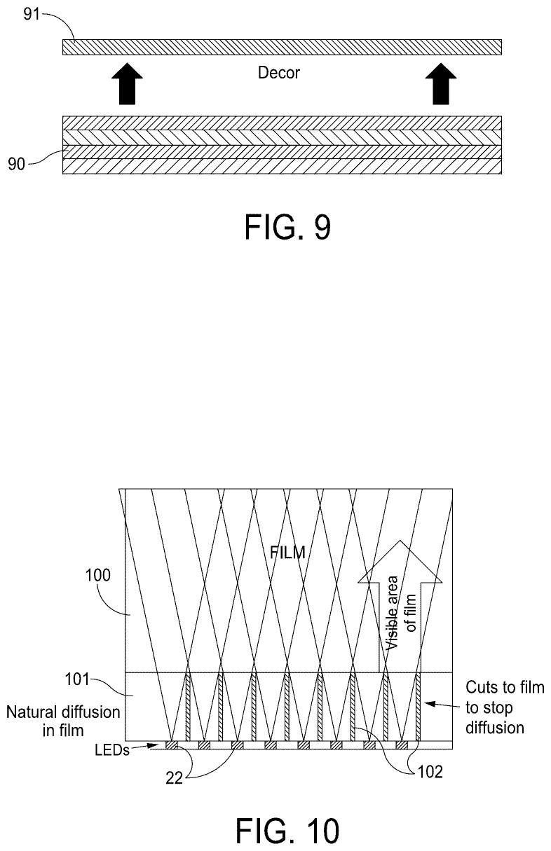

Several configurations of a light guide orientation with respect to a reflective display or graphic decor are shown in FIGS. 6 to 9. FIGS. 6 to 9 are representative side views of light guides that can illuminate decors with the arrows representing the direction of light. FIG. 6 shows that a light guide 60, similarly constructed to the light guide 40 shown in FIG. 4, can emit light from one major surface in one direction to illuminate a decor 61. FIG. 7 shows that a light guide 70, similarly constructed to the light guide 40 shown in FIG. 4, can emit light from an opposite major surface in an opposite direction to illuminate a decor 71. FIG. 8 shows that a light guide 80, similarly constructed to the light guide 40 shown in FIG. 4 minus a bottom protective layer, can emit light from a major surface in a direction to illuminate a decor 81. FIG. 9 shows that a light guide 90, similarly constructed to the light guide 40 shown in FIG. 4 minus a top protective layer, can emit light from an opposite major surface in an opposite direction to illuminate a decor 91.

In some embodiments it is desirable to maintain separation of illuminating regions to create certain lighting patterns or effects. For example, it is possible to include light diffusion control features into a light guide to provide more narrow lighting patterns than the lighting pattern shown in FIG. 3. FIG. 3 shows that light emitted from an LED 22 can begin to diffuse as soon as it enters the light guide 26. FIG. 10 shows a configuration of a lighting unit arrangement to limit lighting diffusion, according to an exemplary embodiment.

Like the configuration of FIG. 3, FIG. 10 shows LEDs 22 emitting light into an edge of a light guide 100. However, portions of the light guide 100 between the location of adjacent LEDs have been cut or removed to create air gaps 102. The air gaps 102 can be long and narrow and extend in a direction perpendicular to the edge of the light guide 100 in which the LEDs emit light. The air gaps 102 can bound channels for light emitted by an LED 22 with light guide/air interfaces that substantially eliminates light travel across the air gaps 102. As a result, the air gaps 102 can eliminate light diffusion from a LED 22 until the light travels through a channel and past the end of the air gaps 102. The air gaps 102 can be located within a zone, i.e., a channel zone 101, that is not visible to a viewer. In some embodiments, the air gap 102 can be filled with a light absorptive material to ensure that light from one LED 22 goes not pass through an air gap 102 into a light channel created for an adjacent LED 22. In some embodiments, a surface of the light guide material at the air gap 102 can be covered with a light absorbing material. In some embodiments, a surface of the light guide material at the air gap 102 can be covered with a light reflecting material.

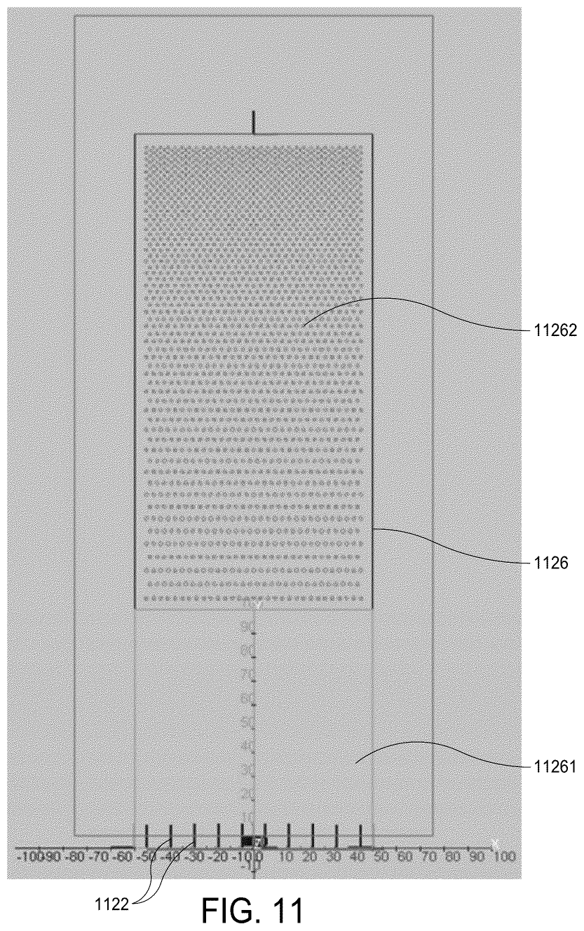

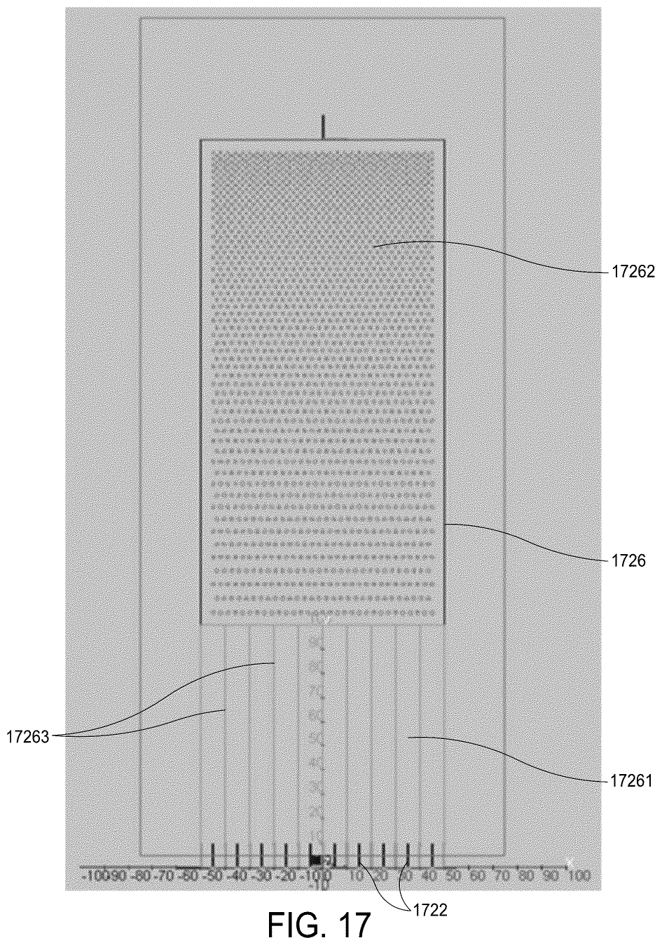

FIGS. 11 to 25 are examples of graphical results of ray tracing simulations that compare light ray paths in a light guide with no air gaps like that shown in FIG. 3 to a light guide with air gaps like that shown in FIG. 10. FIGS. 11 to 16 result from a ray tracing simulation in a light guide with no air gaps, like that shown in FIG. 3 FIGS. 17 to 25 result from a ray tracing simulation in a light guide with air gaps, like that shown in FIG. 10.

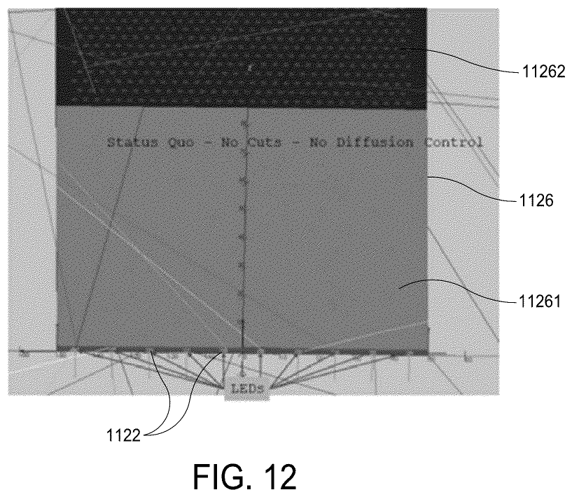

FIG. 11 shows one example of a planar view of a no-gap simulation construct that includes 10 white-light LEDs 1122 (one each at the blue vertical lines), spaced at a regular interval across the X (red) scale, emitting light into an edge of a rectangular light guide 1126 in a direction of the Y (green) scale. The light guide 1126 can include a diffusion zone 11261 and a homogeneous zone 11262. As shown, the homogeneous zone 11262 can include a pattern of dots on a surface of the light guide 1126 used to extract light. FIG. 12 is an example of a closer view of the same no-gap simulation construct shown in FIG. 11.

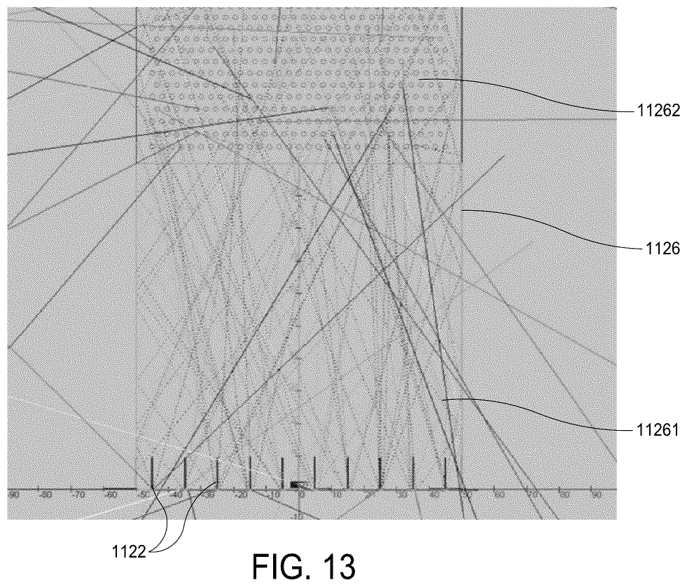

FIGS. 13 to 16 show examples of simulation results of a no-gap simulation construct. In FIG. 13, light rays within the light guide 1126 are depicted with dotted lines. Light rays that have exited the light guide 1126 are represented by solid lines. As shown in FIG. 13, light rays emitted from the LEDs 1122 that have entered the light guide 1126 can be randomly distributed within the diffusion zone 11261.

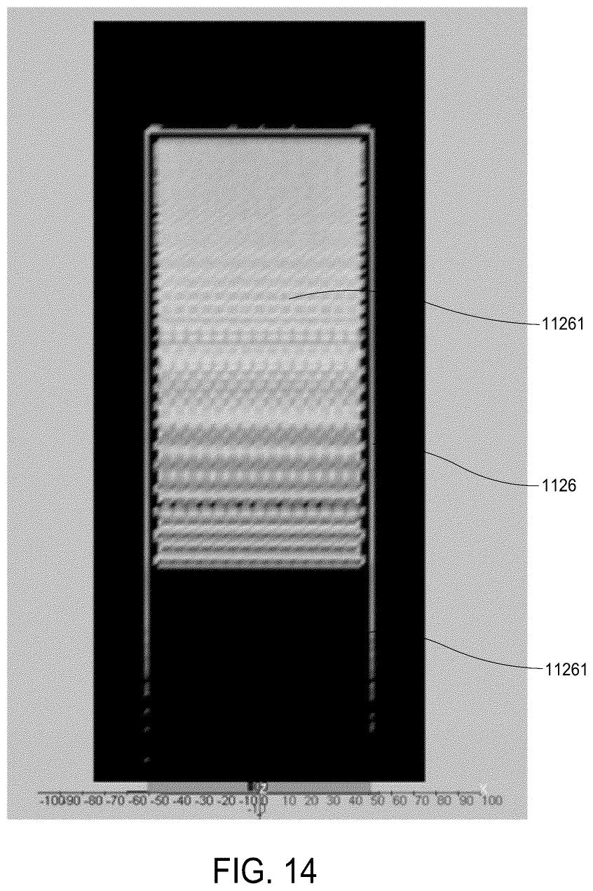

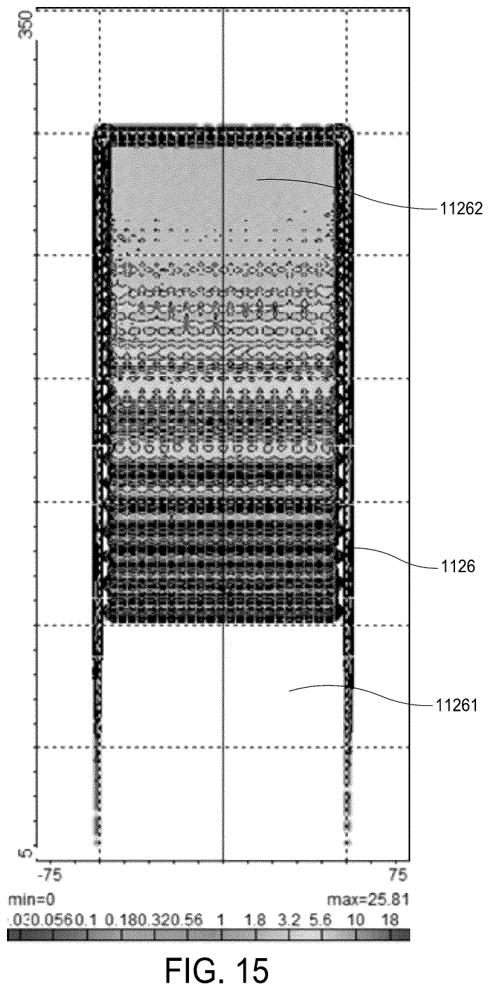

FIG. 14 is a different view of the simulation results where different colors represent relative light output. Although FIG. 14 shows that some light has escaped along the edges, no light may be emitted from the diffusion zone 11261 and most of the light can be output from the homogeneous zone 11262. FIG. 15 is a different view of the simulation results that also can include a colored logarithmic scale of relative light output.

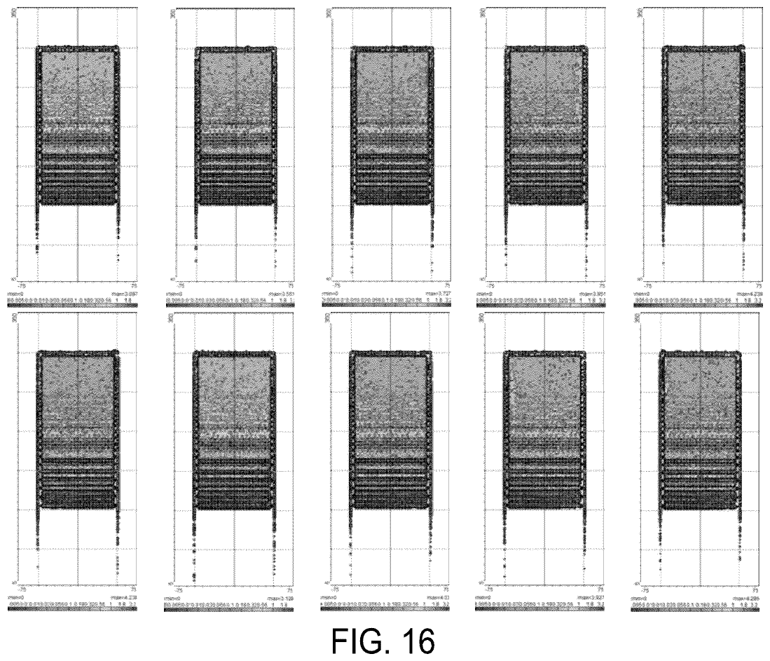

FIG. 16 is a view similar to FIG. 15 but shows the light output contribution for each LED 1122. In the simulation, LEDs 1122 are numbered one to ten from left to right across the edge of the light guide 1126. The top row in FIG. 16 represents light output from LEDs one to five from left to right and the bottom row represents LEDs six to ten from left to right. As shown, there is some non-uniformity in the lower portions of the homogeneous zone for each of the LEDs 1122 with overall light output consistent between the one to ten LEDs 1122.

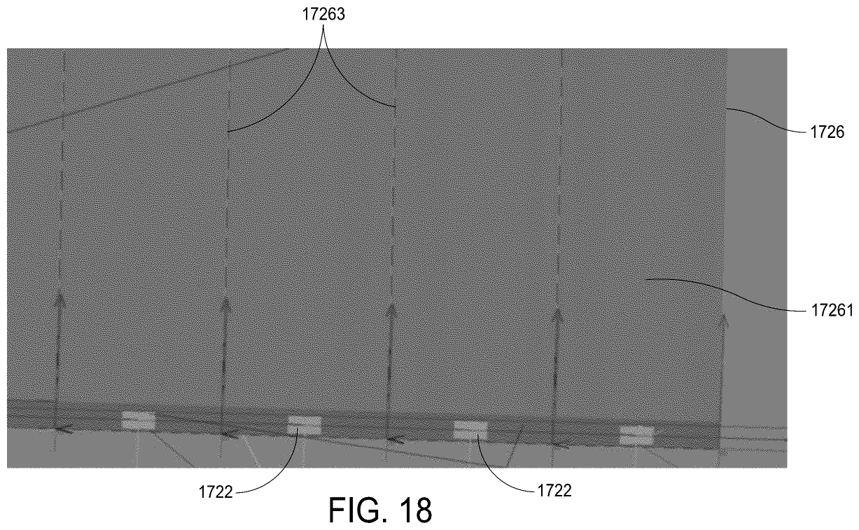

FIG. 17 shows one example of a planar view of a gap simulation construct that includes 10 white-light LEDs 1722 (one each at the blue vertical lines), spaced at a regular interval across the X (red) scale, emitting light into an edge of a rectangular light guide 1126 in a direction of the Y (green) scale. The light guide 1726 can include a diffusion zone 17261 and a homogeneous zone 17262. As shown, the diffusion zone 17261 can include multiple air gaps 17263 that can extend in a straight line through the diffusion zone 17261 from the edge of the light guide 1726 illuminated by the LEDs 1722 to the homogeneous zone 17262. As shown, the homogeneous zone 17262 can include a pattern of dots on a surface of the light guide 1726 used to extract light. FIG. 18 is one example of a closer view of the same gap simulation construct shown in FIG. 17.

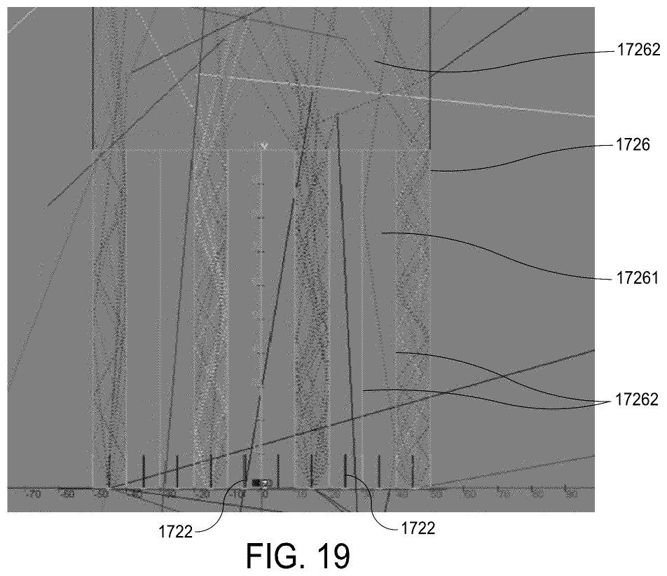

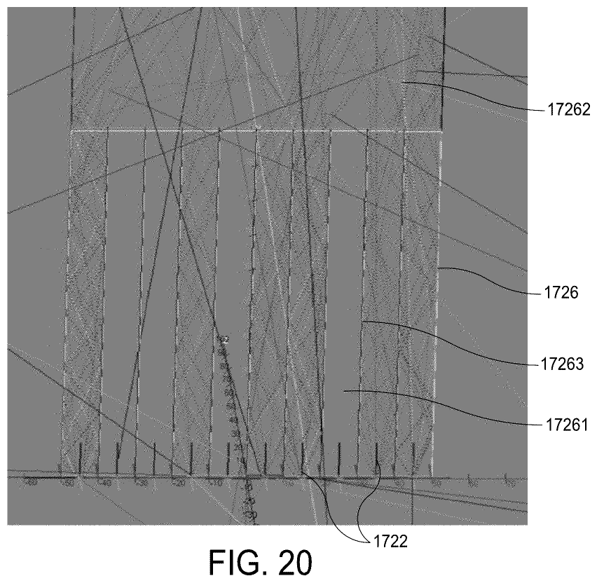

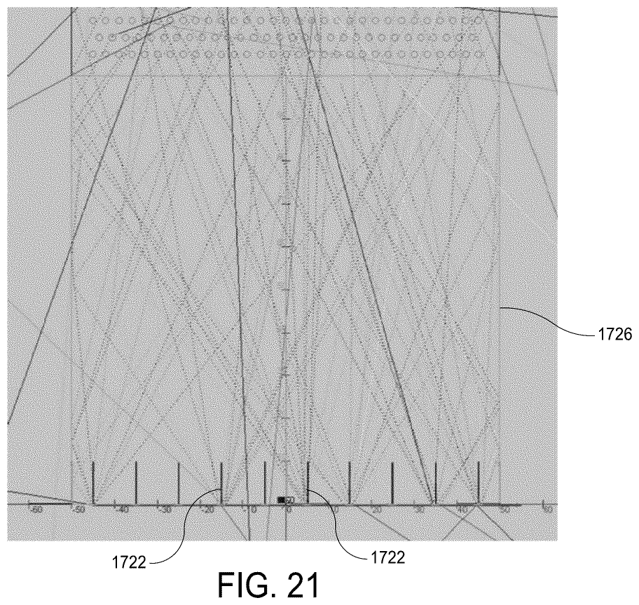

FIGS. 19 to 25 are examples showing simulation results of a gap simulation construct. In FIG. 19, light rays within the light guide 1726 are depicted with dotted lines. Light rays that have exited the light guide 1726 are depicted with solid lines. In FIG. 19, of the ten LEDs 1722, LEDs one, four, seven, and ten have been turned on. As shown in FIG. 19, light rays emitted from the turned on LEDs 1722 that have entered the light guide 1726 can stay within the channels defined between the air gaps 17263 through total internal reflection before becoming randomly distributed after entering the homogeneous zone 17262. FIG. 20 is a perspective view of one example of simulation results with LEDs one, four, six, seven, nine, and ten turned on. In FIG. 20, the Z scale is blue. FIG. 21 is a view of a surface of the light guide 1726 with a configuration similar to the simulation shown in FIG. 20 but without any diffusion control features. FIG. 21 is used to compare the benefits of the diffusion control features shown in FIG. 20 with the same lighting setup that does not have diffusion control features.

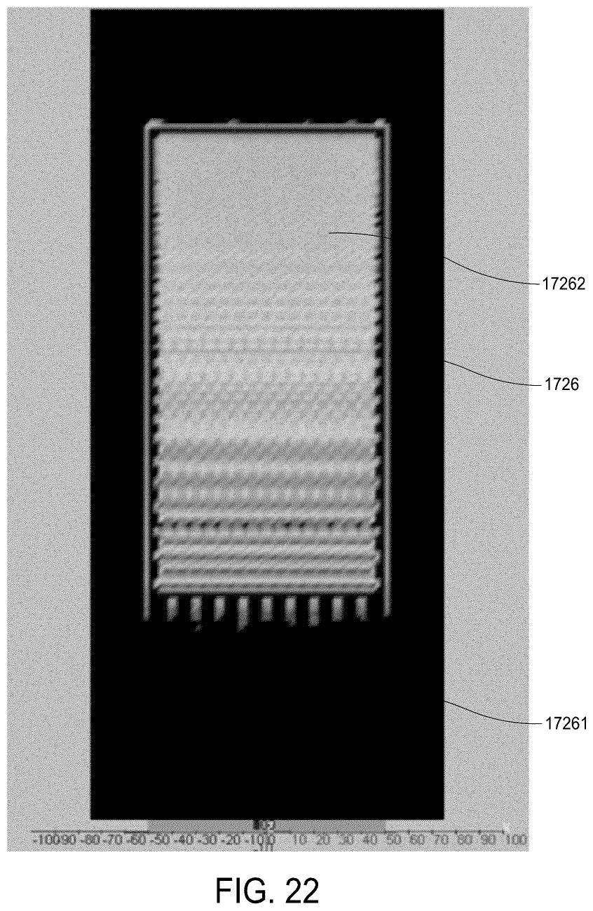

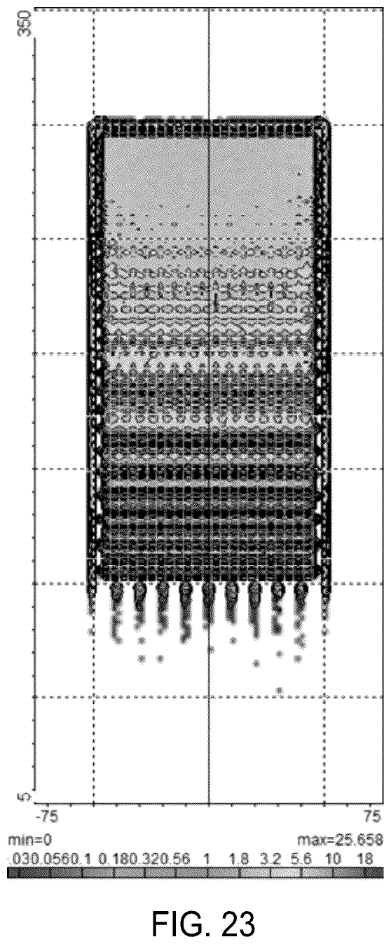

FIG. 22 is one example of a different view of the simulation results where different colors represent relative light output. FIG. 22 shows that some light may escape within the channels in a portion of the diffusion zone 17261 near the homogeneous zone 17262. Although the simulation shows that some light can be emitted from the diffusion zone 17261, most (e.g., a majority) of the light can be output from the homogeneous zone 17262. FIG. 23 is a different view of the gap simulation results that also includes a colored logarithmic scale of relative light output.

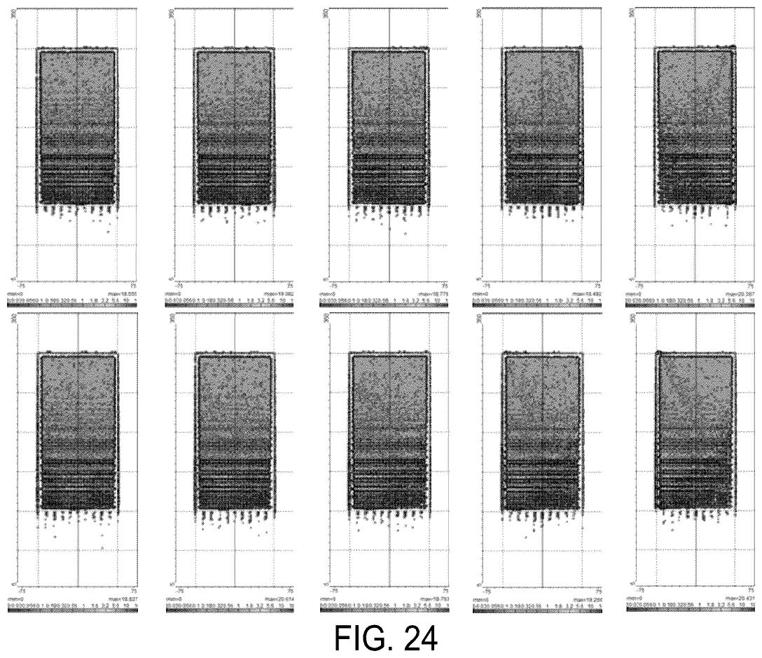

FIG. 24 is a view similar to FIG. 23 but shows the light output contribution for each LED 1722. The top row in FIG. 24 represents light output from LEDs one to five, with LED one being the leftmost and LED five being the right most. The bottom row of FIG. 24 represents LEDs six to ten, with LED six being the leftmost (i.e., beneath LED one) and LED ten being the rightmost (i.e., beneath LED five). As shown, there is less light output than that shown in the no-gap simulation shown in FIG. 16. Additionally, there is more non-uniformity in the lower portions of the homogeneous zone for each of the LEDs 1722 as compared to the no-gap simulation.

The simulations show that inclusion of air gaps to create light channels for respective LEDs can be an effective way to reduce light diffusion in a light guide.

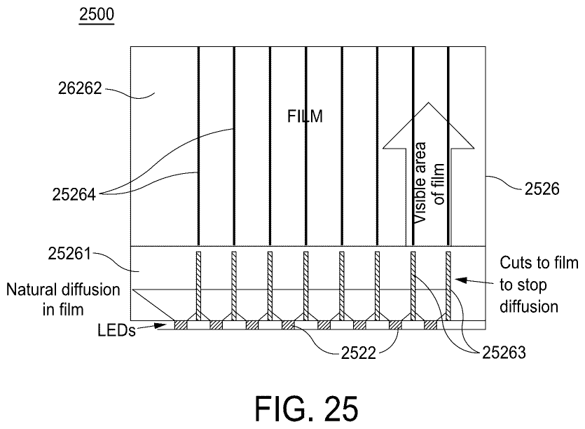

FIG. 25 is one example of a front planar view of a portion of a lighting unit 2500 according to another embodiment. Like the configuration of FIG. 10, FIG. 25 shows LEDs 2522 emitting light into an edge of a light guide 2526. Portions of the light guide 2526 between the location of adjacent LEDs 2522 have been cut or removed to create air gaps 25263 in the channel zone 25261. As previously described, the air gaps 25263 can be long and narrow and extend in a direction perpendicular to the edge of the light guide 2526 in which the LEDs 2522 emit light to bound channels for light emitted by an LED 2522. In some embodiments, the air gap 25263 can be filled with a light absorptive material to ensure that light from one LED 2522 goes not jump an air gap 25263 into a light channel created for an adjacent LED 2522. In some embodiments, a surface of the light guide material at the air gap 25263 can be covered with a light absorbing material. In some embodiments, a surface of the light guide material at the air gap 25263 can be covered with a light reflecting material.

In this lighting unit 2500, the light guide 2526 can also include a series of absorptive lines 25264 located in the homogeneous zone 25262. The absorptive lines 25264 can be parallel to each other and extend from the channel zone 25261 across the light guide 2526. The absorptive lines 25264 can be located on the front surface of the light guide 2526, the rear surface of the light guide 2526, or both. The absorptive lines 25264 can absorb or block light that would normally be diffused in the homogeneous zone 25262. The absorptive lines 25264 can be aligned with the air gaps 25263 such that they effectively help extend the lighting channel for a respective one of the LEDs 2522. That is, the absorptive lines 25264 can absorb or block light that would normally be diffused from one channel to an adjacent channel. The absorptive lines 25264 can be provided alone or in combination with the air gaps 25263 to provide additional diffusion control over the entire length of the light guide 2526.

The absorptive lines 25264 can be made of carbon black, paint, ink, or any other suitable material and color and be applied by spraying, brushing, printing, adhesive, or any other suitable method. The length and width of the absorptive lines 25264 can be adjusted to minimize visibility and manage their light diffusing properties.

It should be understood that the foregoing description is only illustrative of the present invention. Various alternatives and modifications can be devised by those skilled in the art without departing from the present invention. Accordingly, the present invention is intended to embrace all such alternatives, modifications, and variances that fall within the scope of the appended claims.

What is claimed is:

1. A lighting assembly comprising:
a light guide; and
a plurality of light sources configured to emit light into an edge of the light guide, wherein the light guide includes a plurality of air gaps arranged such that each air gap of the plurality of air gaps (i) is parallel to another air gap, (ii) is between adjacent light sources of the plurality of light sources, and (iii) extends in a direction in which light from the plurality of light sources is propagating in the light guide.

2. The lighting assembly of claim 1, wherein
the light guide includes a diffusion zone on a side closest to the plurality of light sources and a homogeneous zone passed the diffusion zone, and
the air plurality of air gaps are in the diffusion zone.

3. The lighting assembly of claim 2, wherein
the diffusion zone is hidden from a viewer, and
light emitted from the plurality of light sources is mixed in the homogeneous zone and viewable by the viewer.

4. The lighting assembly of claim 3, wherein the light guide is flexible such that the diffusion zone is wrapped around and located behind a background.

5. The lighting assembly of claim 1, wherein the plurality of air gaps are configured to substantially eliminate light travel across the plurality of air gaps.

6. The lighting assembly of claim 1, wherein the plurality of air gaps are filled with a light absorptive material.

7. The lighting assembly of claim 1, wherein a surface of the light guide at the plurality of air gaps is covered with a light absorbing material.

8. The lighting assembly of claim 1, wherein a surface of the light guide at the plurality of air gaps is covered with a light reflecting material.

9. The lighting assembly of claim 1, wherein the plurality of light sources includes a plurality of light-emitting diodes.

10. The lighting assembly of claim 1, wherein the light guide includes a protective layer disposed on at least one major surface.

11. The lighting unit of claim 1, wherein the light guide further includes a plurality of parallel light absorptive lines that are respectively aligned with at least one air gap of the plurality of air gaps.

12. The lighting unit of claim 11, wherein the plurality of light absorptive lines are located on a major surface of the light guide.

13. The lighting unit of claim 11, wherein the plurality of light absorptive lines are located on two major surfaces of the light guide.

14. A décor that is front lit by the lighting assembly of claim 1.

15. A display system comprising:
a reflective display;
a background disposed behind the reflective display; and
a lighting assembly configured to front light the reflective display, wherein the lighting assembly includes a light guide, a plurality of light sources configured to emit light into an edge of the light guide, a plurality of air gaps arranged in the planar light guide such that each air gap of the plurality of air gaps (i) is parallel with another air gap, (ii) is between adjacent light sources of the plurality of light sources, and (iii) extends in a direction in which light from the plurality of light sources is propagating in the light guide.

16. The display system of claim 15, wherein
the light guide includes a diffusion zone on a side closest to the plurality of light sources and a homogeneous zone passed the diffusion zone, and
the air plurality of air gaps are located in the diffusion zone.

17. The display system of claim 16, wherein
the diffusion zone is hidden from a viewer, and
light emitted from the plurality of light sources is mixed in the homogeneous zone and viewable by the viewer.

18. The display system of claim 17, wherein the light guide is flexible such that the diffusion zone is wrapped around and located behind the background.

19. The display system of claim 17, wherein the diffusion zone is located within an enclosure.

20. The display system of claim 15, wherein the light guide further includes a plurality of parallel light absorptive lines that are respectively aligned with at least one air gap of the plurality of air gaps.
